(19) United States
(12) Patent Application Publication
(10) Pub. No.: US 2021/0177234 A1
(43) Pub. Date: Jun. 17, 2021

(54) Machine for Washing Accessories

(71) Applicant: Vicente Monzó Peiro, Valencia (ES)

(72) Inventor: Vicente Monzó Peiro, Valencia (ES)

(21) Appl. No.: 16/758,715

(22) PCT Filed: Oct. 10, 2018
(86) PCT No.: PCT/ES2018/070659

§ 371 Date: Apr. 23, 2020

(30) Foreign Application Priority Data
Oct. 23, 2017 (ES) U201731270

(51) Int. Cl. A47L 15/00; A47L 15/30; A47L 15/50

(52) U.S. Cl. CPC A47L 15/0092; A47L 15/502; A47L 15/30

(57) ABSTRACT

The invention relates to a machine that may include an inside space housing a frame which is configured to support at least one accessory to be washed. The frame is connected to a front shaft that is also configured to rotate during the washing of the accessory. The frame may include a cross-member connected to the front shaft, a base formed by two angular supports that include first branches which are coupled to the cross-member, and second branches on which the accessory to be washed rests. The two angular supports of the base have a first adjustment for varying the height thereof in a substantially vertical plane, and the angular supports of the base have a second adjustment for varying the distance between the two angular supports of the base in a substantially horizontal plane.

### CROSS-REFERENCE TO RELATED APPLICATIONS

This application is the United States national phase of International Application No. PCT/ES2018/070659 filed Oct. 10, 2018, and claims priority to Spanish Patent Application No. U201731270 filed Oct. 23, 2017, the disclosures of which are hereby incorporated by reference in their entirety.

### BACKGROUND OF THE INVENTION

### Object of the Invention

The present invention relates to a machine for washing supermarket accessories, although the machine is specially designed for the washing and disinfection of shopping baskets, both hand baskets and wheeled baskets. The configuration of the machine enables the size thereof to be considerably reduced making it more ergonomic and also enables there to be an easier and more comfortable access to the different mechanisms of said machine in case of eventual revisions and repairs. The machine also enables the use of various tools designed specifically for washing and disinfecting other items, such as trays, knives, butcher's and fishmonger's gloves, etc.; and in general, utensils and accessories used in supermarkets, butchers' shops, fishmongers and similar.

### Technical Problem to be Resolved

At present, dishwashers are known that are configured to carry out the washing of cutlery and other elements, such as different containers, all elements that are kept inside the dishwasher in a static position during washing, such that in some cases the washing of said containers is somewhat deficient, mainly due to the fact that the various surfaces of said containers are washed by the spraying of the liquid fluid coming out of injection nozzles from fixed directions, with the possibility that certain areas of the surfaces of said containers do not receive the spraying of the liquid fluid, or even receiving it is not sufficiently effective to carry out the cleaning of the containers.

Furthermore, at present the washing of baskets and trays is generally done manually, so this way of washing is expensive and in some cases it is not efficient enough.

Also known are the rotary basket washing machines that comprise an inside space where a frame with means of securing the basket is located; where said frame together with the basket rotate during the washing phase by means of a motor element that transmits the movement thereof to a shaft connected to the frame by means of a transmission mechanism. The location of the motor element and the transmission mechanism are located in an area of the machine that is difficult to access, making it difficult to assemble and maintain the machine.

Another drawback of these machines is that the means for securing baskets comprise complex anchoring devices that excessively lengthen the time taken to secure the basket; they are also inflexible and ineffective anchoring devices in the sense that it is quite difficult to secure some basket models.

### SUMMARY OF THE INVENTION

In order to achieve the objectives and avoid the drawbacks mentioned in the previous sections, the invention proposes a machine for washing accessories that comprises an inside space that houses a frame configured to support at least one accessory to be washed; wherein the frame is connected to a front shaft that is configured to rotate during the washing of the accessory.

The front shaft is further configured to drag the frame during the rotation thereof which includes anchoring devices configured to secure the accessory to the frame.

The frame comprises a cross-member connected to the front shaft and a base formed by two angular supports that include first branches that couple to the cross-member, and second branches on which the accessory to be washed rests.

The two angular supports of the base have a first adjustment to be able to vary their height positioning in a substantially vertical plane, and the angular supports of the base have a second adjustment to be able to vary the distance between the two angular supports of the base in a substantially horizontal plane.

The first branches of the base of the frame include a set of first through holes, and the cross-member of said frame includes second through holes; wherein the first branches of the base are coupled to the cross-member by means of anchoring elements that fit into some of said first through holes of the first branches and into some of the second through holes when they are facing each other.

The second branches at the base of the frame are fastened to a lower portion of the first branches of said base; wherein the first branches include lower supports where ends of the second branches are fastened to the first branches by means of fastening elements.

The second branches of the angular supports that make up the base include guides that are configured to be able to couple therein opposite edges of a tool that supports at least one accessory to be washed.

The guides of the second branches comprise some longitudinal conduits arranged along said second branches of the base of the frame.

Each of the second branches of the base comprises a structure formed by a main part with an angular profile and a removable secondary part also with an angular profile, which has pins configured to fit into holes located in the main part; wherein the structure of the second branches is configured to vary the width of the guides formed by the longitudinal conduits to adapt them to the width of the opposite edges of the tool when coupled to the guides of the base of the frame.

In one embodiment of the invention, it comprises a first tool with a tray configuration including parallel conduits; in a second embodiment it comprises a second tool including a set of raised supports configured to support gloves; and in a third embodiment of the invention it comprises a grate structure configured to support knives and other cutlery.

In a main embodiment of the invention, the frame is intended to secure a shopping basket resting on the second branches of the angular supports making up the base of the frame; wherein the basket is immobilised by means of the securing devices located at end portions of the second branches of the two angular supports forming the base of the frame.

At the highest point thereof, the machine comprises a mortise located above the inside space where the frame is housed; wherein inside said mortise there is at least one motor element configured to transmit rotary movement to the front shaft to which the frame assembly is connected by means of the cross-member thereof.

The mortise is accessible through an upper removable cover located in a horizontal plane opposite a bottom side of said mortise, while control buttons are located on a front plate which partly defines the lateral contour of said mortise.

The rotary frame is completely designed to achieve greater simplicity and safety in the anchoring of the accessory to be washed and, above all, to enable dimensional adjustment to any size and shape of the accessory to be washed.

Therefore, the cross-member on which the two angular supports are arranged is now used in a totally adjustable way (vertically and horizontally), which angular supports are in the shape of a bracket, located in parallel, each of which includes own means thereof for blocking and fastening the accessory to be washed.

The motor element to provide the rotation of the frame is located in the upper mortise above the inside space; wherein the control and adjustment electronics are also located in said upper mortise.

This allows us to considerably reduce the size of the machine and to have an easier and more comfortable access to the transmission system in case of eventual revisions and/or repairs.

It should be noted that the machine of the invention has removed any tank or reservoir of liquid fluid in the lower portion, which is replaced by the cleaning tank itself, for which a heating resistor is located in said cleaning tank; thus achieving a considerable reduction in the size of the machine, making it more ergonomic.

The very structure and multiple adjustments of the new bracket-shaped supports, which are also equipped for quick anchoring, allow us to use the various tools designed specifically for washing and disinfecting knives, butcher's or fisherman's gloves, etc.

Next, to help better understand this specification and as an integral part thereof, a series of figures is attached in which the object of the invention is depicted in an illustrative and non-limiting manner.

### BRIEF DESCRIPTION OF THE DRAWINGS

FIG. 1 shows a perspective view of the machine for washing accessories, object of the invention. The machine includes a door to access an inside space where the accessories are located for the washing thereof.

FIG. 2 shows a perspective view of the machine with the door open, which shows the inside space where the accessories are located for the washing thereof.

FIG. 3 shows a perspective view of a frame that is located inside the inside space of the machine; wherein said frame is configured to support the accessories during the washing thereof inside the inside space of the machine.

FIG. 4 shows another perspective view of the machine of the invention, wherein a detail of a drain cup is highlighted.

FIG. 5 shows a perspective view of a first tool with a tray configuration that can be coupled to the frame.

FIG. 6 shows a perspective view of a second tool that can be further coupled to the frame.

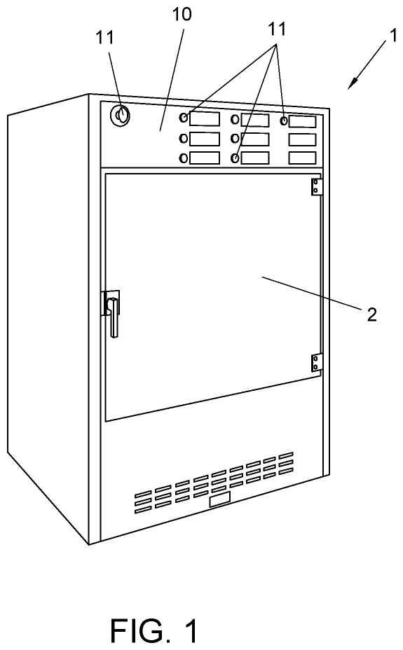

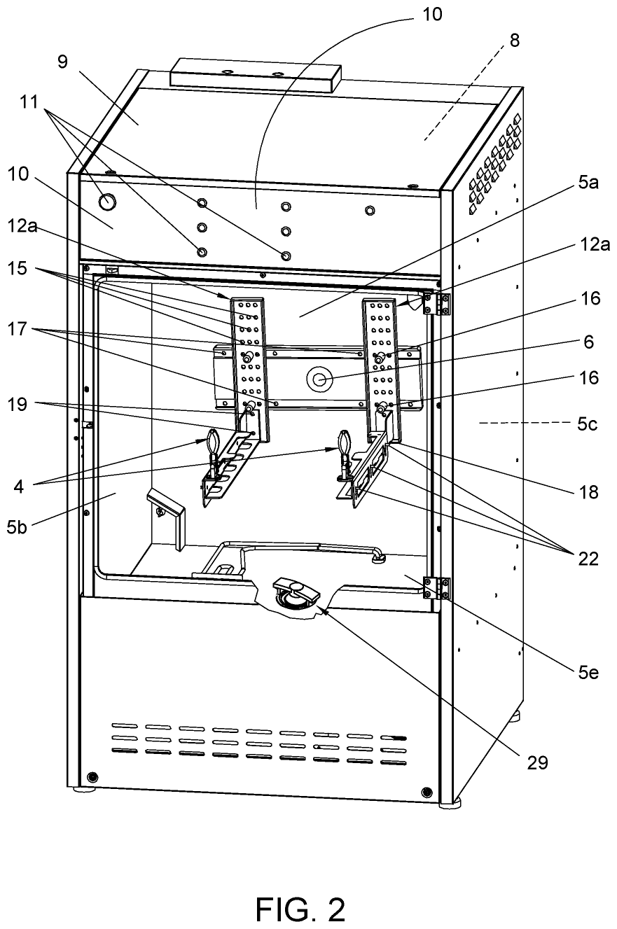

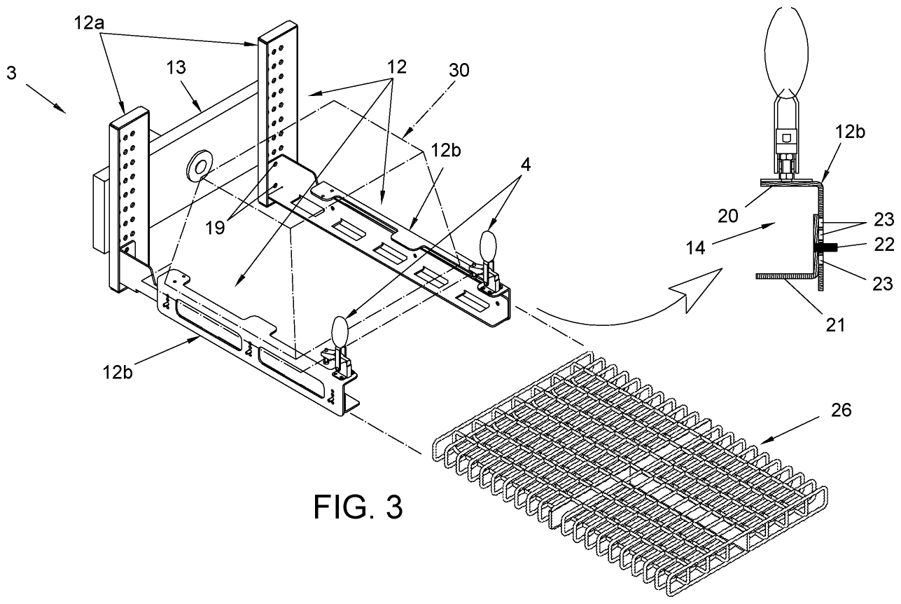

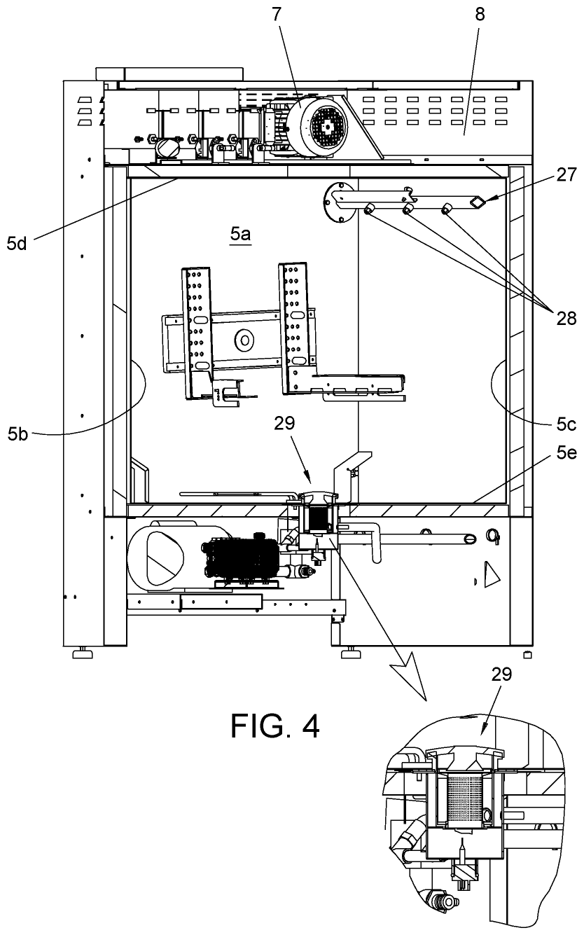

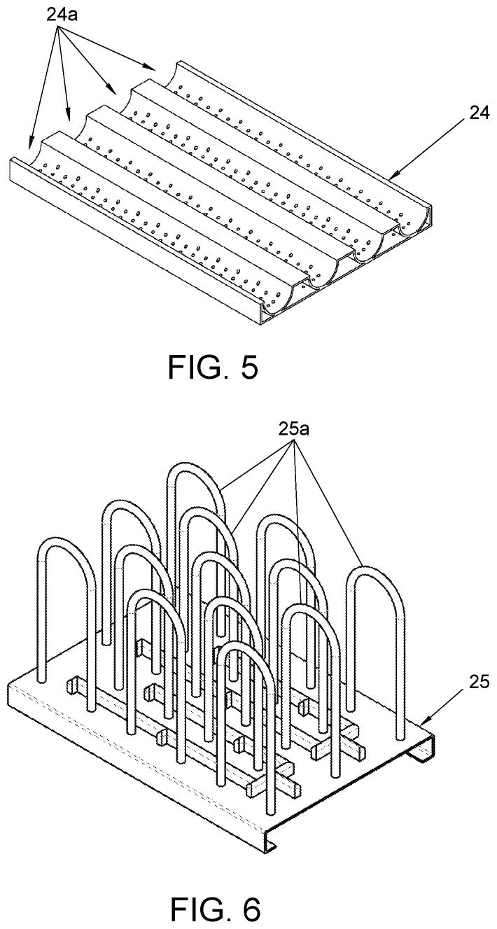

### DETAILED DESCRIPTION OF THE INVENTION

Considering the numbering adopted in the figures, the machine 1 for washing accessories comprises a structure that includes an inside space that is accessible through a hinged door 2 configured to be able to close a front mouth of this inside space where a frame 3 is located.

The frame 3 is configured to rotate during the washing of the accessories that are immobilised on the frame 3 by means of two fastening devices 4 that are coupled to the frame 3.

The inside space of the machine is delimited by the door 2 itself in a closed position, a front wall 5a opposite the front mouth, two opposite side walls 5b, 5c, a ceiling wall 5d and a floor wall 5e opposite the ceiling wall 5d.

The frame 3 is cantilevered to an end section of a front shaft 6 located in correspondence with the front side wall 5a; wherein the frame 3 is connected to the front shaft 6; and wherein said front shaft 6 is configured to rotate by means of a motor element 7 which transmits the rotary motion thereof to the front shaft 6 by means of a transmission mechanism.

The machine 1 of the invention includes, in the highest portion thereof, a mortise 8 located above the inside space where the frame 3 is housed, such that the motor element 7 and other devices and elements of the machine are located inside said mortise 8.

The mortise 8 is easily accessible by means of an upper removable cover 9 which is located in a horizontal plane opposite a bottom side of said mortise 8 while control buttons 11 are located on a front plate 10 which partly defines the lateral contour of the mortise 8.

The frame 3 has a two-dimensional adjustment of the space to be able to adapt to different dimensions of baskets 30 to be washed; it should also be noted that the machine of the invention enables different tools (described below), on which different accessories are supported, to be mounted on the frame 3, such as cutlery and metal gloves for fishmongers and butchers.

In addition, it should be noted that the frame 3 includes a height-adjustable base 12 to be able to place the accessories at different heights in order to thus achieve the best possible result from washing said accessories.

The frame 3 comprises the height-adjustable base 12 and a cross-member 13 by means of which the whole of the frame 3 is fastened to the front shaft 6.

The height-adjustable base 12 comprises two angular supports that include first parallel branches 12a that are coupled to the cross-member 13, and second parallel branches 12b on which the basket 30 to be washed is supported.

The first branches 12a are arranged in a substantially vertical plane, while the second branches 12b of the base 12 are arranged in a substantially horizontal plane.

The second branches 12b include parallel guides 14 to enable the various tools to be coupled; wherein said guides comprise longitudinal conduits arranged along the second branches 12b of the base 12 of the frame 3.

The first branches 12a of the base of frame 3 include a set of first through holes 15 in order to fasten said base 12 to the cross-member 13 of said frame 3 by means of anchoring elements 16 which fit into some of said first through holes 15 and into some of the second through holes 17 of the cross-member 13 when both sets of through holes 15, 17 are facing each other.

The second branches 12b of the base 12 of the frame 3 are fastened to a lower portion of the first branches 12a of said base 12; wherein the first branches 12a include lower supports 18 wherein ends of the second branches 12b rest, which are fastened to the first branches 12a by means of fastening elements 19.

Each of the second branches 12b of the base 12 comprises a main part 20 with an angular profile and a removable secondary part 21 which has pins 22 configured to fit into holes 23 located in the main part 20, so that it is possible to vary the width of the guides to adapt them to the width of the different tools; such as for example a first tool 24 with a tray configuration that includes parallel conduits 24a; a second tool 25 that includes a set of raised supports 25a to support gloves; a third tool 26 that includes a grate structure to support knives and other cutlery.

The frame 3 includes anchoring devices 4 which are located at end portions of the second branches 12b of the base 12; wherein these anchoring devices 4 are configured to safely secure a basket 30 to the frame 3.

The machine of the invention includes injectors 28 through which the liquid fluid for washing the accessories comes out when they are supported on the frame 3; wherein said injectors are located on at least one arm 27 fastened on the front wall 5a which partly delimits the inside space.

On the floor wall 5e of the inside space is located a drainage cup 29 which houses a removable filtering cartridge and the drainage cup 29 of which incorporates a level sensor to indicate to the system when to activate the recirculation or drainage of the water collected.

This system, which is similar to that of conventional dishwashers, is very effective and prevents the malfunctioning of a booster pump that is responsible for pushing the liquid fluid for washing the accessories.

It should be noted that in some washing phases, the liquid fluid collected is sent by means of a three-way solenoid valve towards the injectors 28 and is reused in the entirety thereof, until the time arrives when it is not reusable and it is diverted towards the drain.

The embodiments illustrated herein are mere examples of the present invention and should therefore not be construed as being limiting. Alternatives provided by a skilled person in consideration of the embodiments are likewise encompassed by the scope of protection of the present invention. Accordingly, the foregoing description is intended to be illustrative rather than restrictive. The invention described hereinabove is defined by the appended claims and all changes to the invention that fall within the meaning and range of equivalency of the claims are to be embraced within their scope.

1. A machine for washing accessories, comprising an inside space housing a frame which is configured to support at least one accessory to be washed, wherein the frame is connected to a front shaft that is configured to rotate during the washing of the accessory, wherein the front shaft is configured to drag the frame during the rotation thereof, wherein the frame includes at least one anchoring device configured to secure the at least one accessory to the frame, wherein the frame comprises a cross-member connected to the front shaft, a base formed by two angular supports that include first branches which are coupled to the cross-member, and second branches on which the at least one accessory to be washed rests, wherein the two angular supports of the base have a first adjustment for varying the height thereof in a substantially vertical plane, and wherein the angular supports of the base have a second adjustment for varying the distance between the two angular supports of the base in a substantially horizontal plane.

2. The machine for washing accessories, according to claim 1, wherein the first branches of the base of the frame include a set of first through holes and the cross-member of the frame includes second through holes, and wherein the first branches of the base are coupled with the cross-member by means of anchoring elements that fit in some of said first through holes of the first branches and in some of the second through holes when they are facing each other.

3. The machine for washing accessories, according to claim 1, wherein the second branches of the base of the frame are fastened to a lower portion of the first branches of the base, and wherein the first branches include lower supports where ends of the second branches are fastened to the first branches by means of fastening elements.

4. The machine for washing accessories, according to claim 1, wherein the second branches of the angular supports that make up the base of the frame include guides that are configured to be able to couple therein opposite ends of a tool that supports the at least one accessory to be washed.

5. The machine for washing accessories, according to claim 4, wherein the guides of the second branches comprise longitudinal conduits arranged along the second branches of the base of the frame.

6. The machine for washing accessories, according to claim 5, wherein each one of the second branches of the base comprises a structure formed by a main part with an angular profile and a removable secondary part with an angular profile, which has pins configured to fit in holes located in the main part, and wherein the structure of the second branches is configured to vary a width of the guides formed by the longitudinal conduits to adapt them to a width of the opposite edges of the tool when it is coupled on the guides of the base.

7. The machine for washing accessories, according to claim 4, wherein the machine comprises a tool with a tray configuration that includes parallel conduits.

8. The machine for washing accessories, according to claim 4, wherein the machine comprises a tool that includes a set of elevated supports configured to support gloves.

9. The machine for washing accessories, according to claim 4, wherein the machine comprises a tool that comprises a grate structure configured to support knives and other utensils.

10. The machine for washing accessories, according to claim 1, wherein two anchoring devices are located in end portions of the second branches of the two angular supports that make up the base of the frame.

11. The machine for washing accessories, according to claim 1, wherein the machine comprises in the uppermost portion thereof, a mortise located above the inside space where the frame is housed, and wherein inside said mortise is located at least one motor element configured to transfer rotary movement to the front shaft.

12. The machine for washing accessories, according to claim 11, wherein the mortise is accessible through an upper removable cover located in a horizontal plane opposite a bottom side of said mortise, while control buttons are located on a front plate which partly defines ea lateral contour of said mortise.
